(19) United States
(12) Patent Application Publication
(10) Pub. No.: US 2017/0036614 A1
(43) Pub. Date: Feb. 9, 2017

(54) Magnetic Fishing Rod Roof Rack For Conveniently Transporting Fishing Rods On Any Metal Roof

(71) Applicant: Zahid Rahman, San Antonio, TX (US)

(72) Inventor: Zahid Rahman, San Antonio, TX (US)

(21) Appl. No.: 14/210,225

(22) Filed: Mar. 13, 2014

Related U.S. Application Data
(60) Provisional application No. 61/784,620, filed on Mar. 14, 2013.

(51) Int. Cl. B60R 9/058; B60R 9/048; B60R 9/08; A01K 97/08

(52) U.S. Cl. CPC B60R 9/058; A01K 97/08; B60R 9/048; B60R 9/08

(57) ABSTRACT

Disclosed is a portable magnetic sporting equipment rack with at least a base coupled to magnets on its underside, and an optional cover. In the preferred embodiment the magnets are strong rare earth neodymium magnets. The magnets are arranged on the underside as “feet” that tightly secure to any metal surface. Such a surface may be the roof of any car, van, truck, SUV, to allow convenient, fast and safe transport of fishing rods on the roof of any vehicle. The rack may be comprised of a base and cover, with straps or other means of securing fishing rods and the cover in place. The piece may also be removed and used as a carrying case or may also serve as ornamental fishing rod storage piece on any metallic surface.

### CROSS-REFERENCE TO RELATED APPLICATIONS & CONTINUITY DATA

This application claims the benefit of provisional application 61/784,620 hereby incorporated by reference in its entirety.

### BACKGROUND OF THE INVENTION

Transporting sporting equipment to various locations often requires specialized racks or other devices be permanently attached to the vehicle. Additional hardware such as screws, bolts, or adhesive may be used to permanently bind a support rack to a vehicles roof. Temporary support structures often require bulky straps that impede the vehicles normal function or simply are not attached securely to the vehicle. The current invention provides for very temporary yet strong and stable attachment to a vehicle to transport sporting equipment.

### FIELD OF THE INVENTION

The invention relates to sporting goods, fishing accessories and automobile accessories.

### SUMMARY OF THE INVENTION

Disclosed is a portable magnetic fishing rod rack with at least a base coupled to magnets on its underside. Certain embodiments may also comprise a cover piece. In the preferred embodiment the magnets are strong rare earth neodymium magnets. The magnets arranged as “feet” that tightly secure to any metal surface, such as the roof of any car, van, truck, SUV, to allow convenient, fast and safe transport of fishing rods on the roof of any vehicle. The rack may be comprised of a base and cover, with straps or other means of securing fishing rods and the cover in place. The rack may be used on any metal surface, and therefore is useful for transportation as well as storage. The disclosed magnetic roof rack serves as an ornamental fishing rod storage piece when on any metallic surface. The invention allows for a unique way of quickly assembling a storage device or storing fishing rods (up to 12′ long in preferred embodiments) with spinning reels or conventional reels, on any car or vehicle. No additional hardware or racks, bars, tools, or assembly is necessary.

### BRIEF DESCRIPTION OF THE DRAWINGS FIGURES

FIG. 1 shows the device with 3 fishing rods being easily carried by the device in carry mode when it is detached from the metal surface.

FIG. 2 shows the device mounted on the roof of a vehicle.

FIG. 3: shows the device attached to a car roof from the rear perspective.

FIG. 4 shows one embodiment of the current invention. Many embodiments will have similar ratios of dimensions and relative measurements.

FIG. 5 shows the basic components of certain embodiments. 1 refers to the optional cover. 2 refers to the base portion 3 refers to the magnetic “feet”.

### DETAILED DESCRIPTION OF THE PREFERRED EMBODIMENTS

Disclosed is a portable magnetic fishing rod rack with at least a base, a cover, and coupled to magnets on its underside. In the preferred embodiment the magnets are strong rare earth neodymium magnets. The magnets arranged as “feet” that tightly secure to any metal surface, such as the roof of any car, van, truck, SUV, to allow convenient, fast and safe transport of fishing rods on the roof of any vehicle. The rack may be comprised of a base and cover, with straps or other means of securing fishing rods and the cover in place. The rack may be used on any metal surface, and therefore is useful for transportation as well as storage. The magnetic roof rack serves as an ornamental fishing rod storage piece when on any metallic surface. The invention allows for a unique way of quickly assembling a storage device or storing fishing rods (up to 12′ long in preferred embodiments) with spinning reels or conventional reels, on any car or vehicle. No additional hardware or racks, bars, tools, or assembly is necessary. When used herein the term “device” or “magnetic rack” unless otherwise described refers to any of the disclosed embodiments comprising the basic elements of the magnetic feet, the base and an optional cover with openings capable of accepting rod or fishing rod like devices.

Preferred embodiments are comprised of a cover and a base. The base may have slots or other indentations to receive fishing rods that rest in the slots and may be secured in place with any number of stretch cords that keep the rods from moving around. Preferred embodiments may utilize two stretch chords. The base in other embodiments may be substantially flat, with protruding clamps, clasps, or other means for fastening to secure the rods in place. Other means of securing the rods will be apparent to those skilled in the art. The cover of the magnetic storage piece may be laid over the base and is secured on to the base by way of a lunch box like clasp. In alternative embodiments other means may be used such as cords, straps, rubber “O” rings, buckles, or other locking devices that will be apparent to those skilled in the art that may secure the top cover to the bottom base.

With particular embodiments of the invention the object of the invention is the use of very strong rare earth magnets to secure a sporting equipment support device to a metal surface. The connection point between the magnets and the base may be of a number of design schemes to allow different functionalities of the magnets. For example the magnets absorb shock and thus are backed by springs. They may also flex or shift to allow for fitting to a curved surface. The design of the support structure, the parts of it accommodating the sporting equipment, may also vary substantially across many different embodiments. Any type of rack previously used in the art may be adapted to connect to a surface via the magnets. The many different embodiments for all these potential designs will be apparent to those skilled in the art.

The cover in the preferred embodiment is rounded in nature as shown in the figures. However it may take any shape in which the rods may be placed beneath and covered by it such as rectangular, conical or otherwise. The magnetic “feet” in nearly all embodiments will be essentially flat or contoured to fit flush with a preferred surface. The number of magnets may range from one or two up to 100 or more. The size of the magnets may also vary from large diameters (12 inches) too smaller diameters (fractions of a centimeter). The material between the magnet and the base of the device may also be such that it allows for bending or adjustment of the positions of the magnets. In such a design the surface of the magnets may be completely flat however the angular shifting of the entire magnet may allow for fitting to a curved surface

The magnetic storage device in preferred embodiments may have 6 magnetic “feet” (in alternative embodiments may range from 1 to 100) that are made from rare earth neodymium magnets. Neodymium magnets are known to be extremely strong magnets and make the rack virtually impossible to move once attached to a car roof or metal surface. To detach the rack one should apply vertical upward pull (lift) from one of the corners of the magnetic storage device. The device does not move or detach under extreme driving and weather conditions or even minor vehicle accidents. With a typical device, disassembly requires the removal of screws or whatever attachment method was used adding time and work to its removal. Additionally, in such a situation use as a carrying case is impractical. With the current device, the magnets provide increased security as an attachment device, and yet they also simplify removal.

The design utilized in all embodiments allows a user to easily attach and detach this magnetic rack on top of their car, van, truck, SUV, or any vehicle with a metal roof. They can then transport their fishing rods easily while freeing up room in their vehicle. Single or multiple piece rods, in some embodiments up to 12 feet in length or more may be transported on small cars with ease. The device uses no roof racks screwed, bolted, or glued to the car, attachments, or supplemental hardware. The device is fully implemented for use simply by setting the magnetic feet down atop the metal surface. One may remove the rods from the rack for use or lift the entire rack off at an angle with the provided release grip, a handle and or lever form factor that transfers the force applied by the user vertically, such that the essentially vertical force needed to separate the magnets from the metal surface is properly directed. Once removed from the vehicle the user may then walk with the rack (with rods/reels) in hand quickly to his/her fishing spot and back.

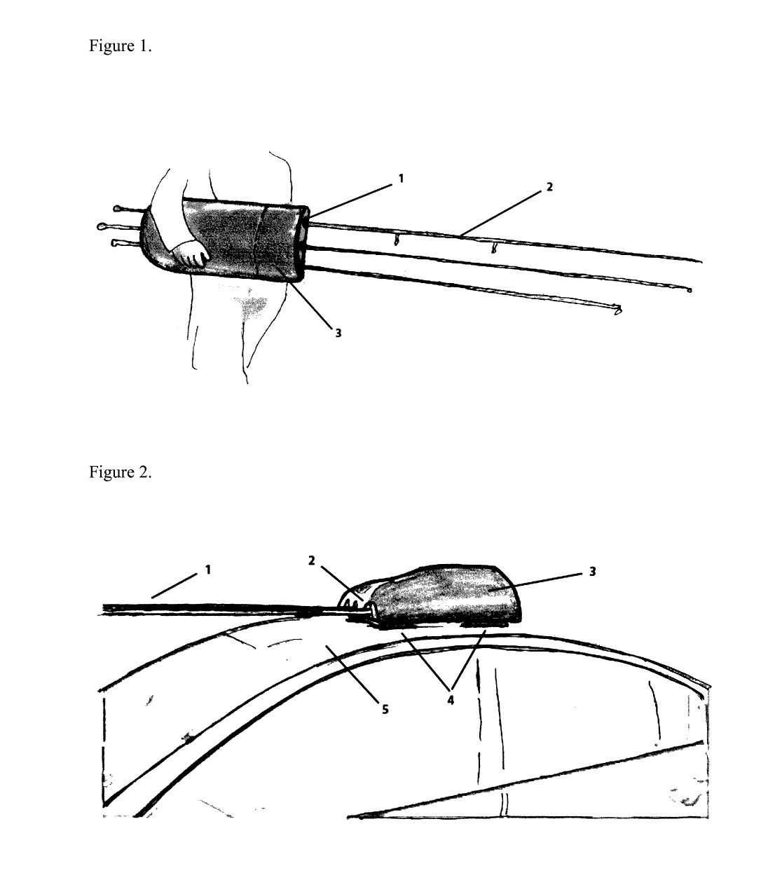

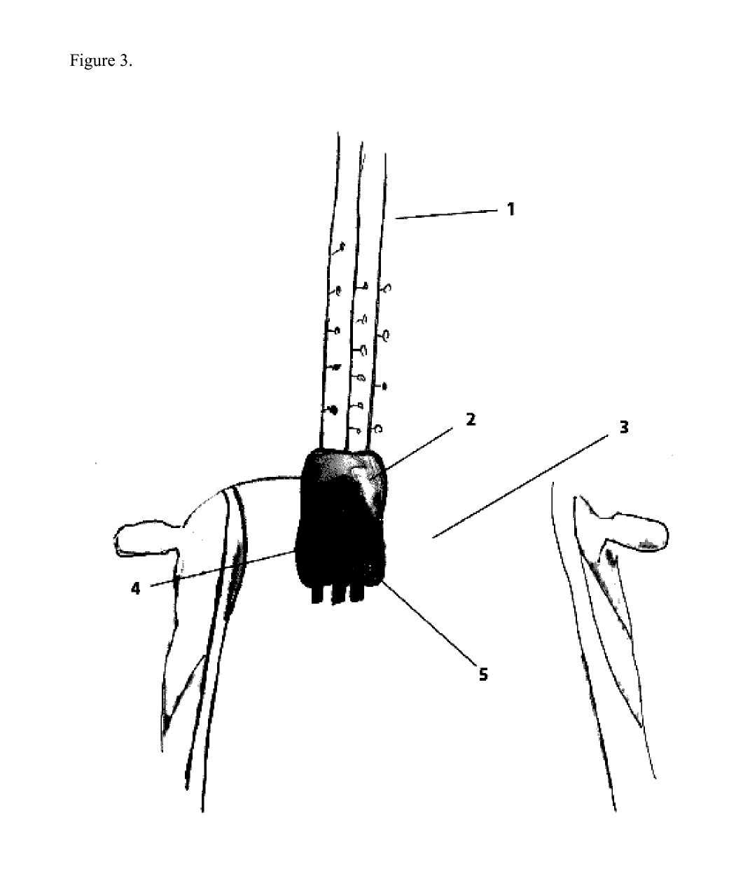

FIG. 1 shows the device with 3 fishing rods being easily carried by the device in carry mode when it is detached from the metal surface. 1 points to the “slots” used in this particular embodiment to hold the rods between the top cover and the base. 2 refers to the fishing rods. 3 Refers to the top cover. FIG. 2 shows the device mounted on the roof of a vehicle. 1 refers to the fishing rods. 2 refers to the “slots” or openings used in this embodiment that accept and hold the rods through the base and cover. 3 refers to the top cover. 4 refers to the two visible magnetic feet in this view of the six feet of this embodiment. 5 refers to the metal surface or vehicle roof. The 3 fishing rods (with reels) shown in this embodiment are up to 10′ long. As shown the rods may be as long as desired, only limited by their flexibility and weight bearing ability, as well as the legal limit for carrying a structure atop a vehicle (which is not a physical constraint). FIG. 3 (shows the device from the rear perspective atop a vehicle. 1 refers to the fishing rods. 2 refers to the top cover as shown from this upper rear view. 3 refers to the metal surface or vehicle roof 4 shows the “slots” or opening in which the fishing rods are held. 5 refers to base portion.

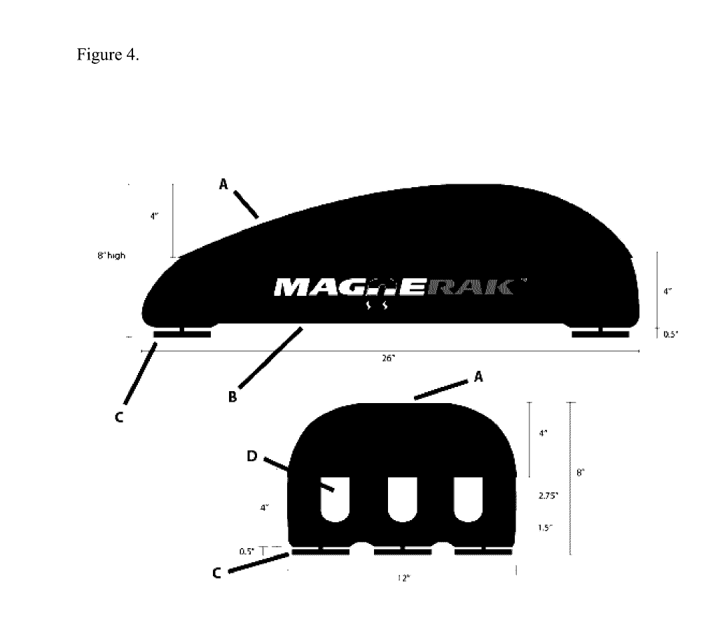

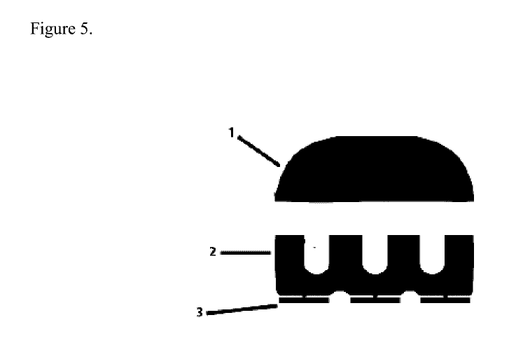

FIG. 4 shows one embodiment of the current invention. Many embodiments will have similar ratios of dimensions and relative measurements. The specs, numbers, designs, sizes, materials, and construction may vary across different embodiments as will be recognized by those skilled in the art. In FIG. 5 A shows the top cover piece. B refers to the bottom portion or base. C refers to one of the magnetic “feet”. D shows the slots or any type of indentation that may be used to accept a fishing rod or other device. The number and type of rods or sporting good devices that can be accommodated may vary substantially.

FIG. 5 shows the basic components of certain embodiments. 1 refers to the optional cover. 2 refers to the base portion. The base portion as mentioned herein may consist of “slots” as shown, or of other fastener means attached to an essentially flat base piece. 3 refers to the magnetic “feet”.

The phrase “in one embodiment” is used repeatedly. The phrase generally does not refer to the same embodiment; however, it may. The terms “comprising,” “having” and “including” are synonymous, unless the context dictates otherwise. The following illustrations of various embodiments use particular terms by way of example to describe the various embodiments, but this should be construed to encompass and provide for terms such as “method” and “routine” and the like.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

The characteristics and utilities of the present invention described in this summary and the detailed description below are not all inclusive. Many additional features and advantages will be apparent to one of ordinary skill in the art given the following description. There has thus been outlined, rather broadly, the more important features of the invention in order that the detailed description thereof that follows may be better understood, and in order that the present contribution to the art may be better appreciated.

In this respect, by explaining at least one embodiment of the invention in detail, it is to be understood that the invention is not limited in its application to the details of construction and to the arrangements of the components set forth in the description. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the description be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way. The characteristics and utilities of the present invention described in this summary and the detailed description below are not all inclusive. Many additional features and advantages will be apparent to one of ordinary skill in the art given the detailed description.

What is claimed is:

1. A sporting equipment transportation device comprising rare earth neodymium magnets.

2. The device of claim 1, wherein the sporting equipment comprises fishing rods.

3. The device of claim 2, wherein the magnets attach to a metal surface.

4. Claim 3, wherein the metal surface is a roof of a vehicle.

5. Claim 4, further comprising a base piece containing slots or indentations capable of holding a fishing rod, which may be further secured into said slots or indentations by straps or stretch cords.

6. Claim 5 wherein the magnets may be backed by springs to absorb shock.

7. Claim 5, wherein the magnet are flat on their bottom surface, but may shift in order to accommodate a curved surface.

8. Claim 6, wherein the magnet are flat on their bottom surface, but may shift in order to accommodate a curved surface.

9. Claim 5, wherein the device is removed from a metal surface only by applying vertical force to at least one point on the device.

10. The device of claim 9, wherein no screws, bolts, adhesives, or other fasteners are used to connect the device to a metal surface.

11. The device of claim 5, wherein the device is removable from the metal surface and may be used as a carrying case for fishing rods.

12. A fishing rod transportation device comprising:
magnets to attach to a metal surface on a vehicle;
a base piece with spaces or fastener means to accommodate the sporting equipment; and
straps to secure the fishing rods in the spaces or fastener of the base piece.

13. Claim 12, wherein the magnets are flat on their bottom surface, but may shift in order to accommodate a curved surface.

14. Claim 12, further comprising springs housed behind the magnets to absorb shock allow the magnets to shift.

15. The device of claim 12, wherein the device is removed from a metal surface only by applying vertical force, and wherein no screws, bolts, adhesives, or other fasteners are used to connect the device to a metal surface.

16. The device of claim 12, wherein the device is removable from the metal surface and may be used as a carrying case for fishing rods.

17. The device of claim 16, further comprising a curved cover piece atop the device.
